(19) United States
(12) Patent Application Publication
(10) Pub. No.: US 2013/0238937 A1
(43) Pub. Date: Sep. 12, 2013

(54) DISPLAY DEVICE AND COMPUTER USING THE SAME

(71) Applicants: YI-XIN TU, Shenzhen City (CN); ZHENG-QUAN PENG, Shenzhen City (CN); ZHAO-YANG CAI, Shenzhen City (CN); HAI-QING ZHOU, Shenzhen City (CN)

(72) Inventors: YI-XIN TU, Shenzhen City (CN); ZHENG-QUAN PENG, Shenzhen City (CN); ZHAO-YANG CAI, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/598,641

(22) Filed: Aug. 30, 2012

(30) Foreign Application Priority Data
Mar. 9, 2012 (CN) 201210061080.2

(51) Int. Cl. G06F 11/26

(52) U.S. Cl. 714/36; 714/E11.159

(57) ABSTRACT

A display device is coupled to a computer, and the computer accommodates a motherboard. The display device includes an interface unit connected to the motherboard, a display panel, and a processor electrically coupled to the interface unit. The processor is used to: receive a power-on self test (POST) code from the motherboard via the interface unit, convert the POST code into a debug code, and control the display panel to display the debug code.

### BACKGROUND

1. Technical Field

The present disclosure relates to display devices, and particularly, to a display device that can convert power-on self test (POST) code into a debug code and display the debug code.

2. Description of Related Art

Many computers will perform a power-on self test (POST) during startup to determine whether hardware is working correctly. The result of a power-on self test (POST) can be displayed, for example, on the display screen of the computer. However, before the display card begins its operation, the user cannot determine whether other electronic devices are operating normally. Additionally, if the computer cannot be initialized normally because the display card cannot operate normally, the user cannot determine whether other electronic devices can operate normally. Furthermore, since the display frame of the test message is usually transient, it is quite difficult for the user to record the test result. One to way to resolve the above problem is by use of audio signals to signal the user various POST messages. However, the user may not easily remember what the various signals mean and have to look them up in the user manual, which is quite inconvenient for the user.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is block diagram of a display device in accordance with an exemplary embodiment.

FIG. 2 is a cross-sectional view of a computer including the display device of FIG. 1.

FIG. 3 is a schematic view of a front side of the display device of FIG. 1.

### DETAILED DESCRIPTION

Embodiments of the present disclosure will be described with reference to the accompanying drawings.

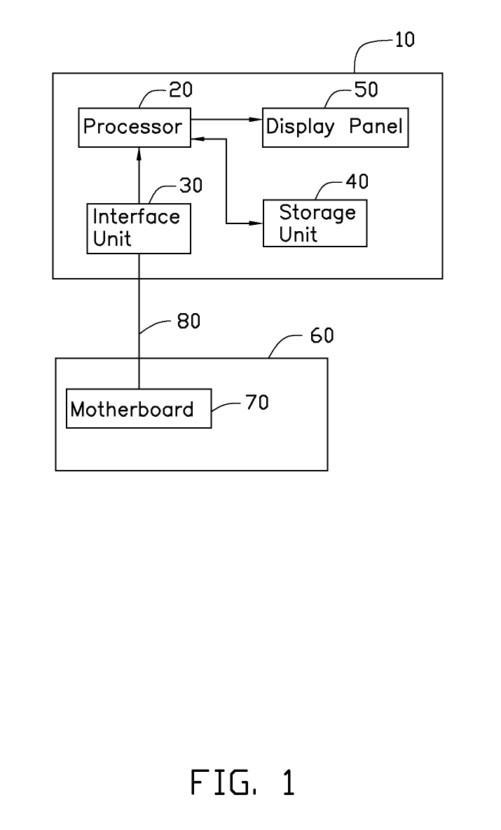

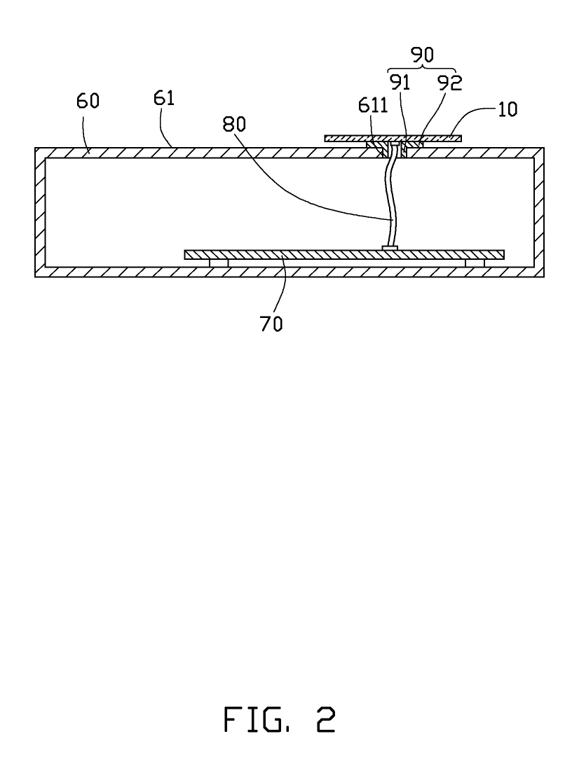

Referring to FIGS. 1 and 2, a display 10 includes a processor 20, an interface unit 30, a storage unit 40, and a display panel 50. The display 10 is electrically coupled to a computer 60, and is electrically connected to a motherboard 70 retained within the computer 60. The display 10 receives debug information from the motherboard 70 when the computer 60 is started.

Specifically, when the computer 60 is started, the basic input and output system (BIOS) will perform a power-on self test (POST) to determine whether the hardware such as the central processing unit (CPU), the disk drives, and the random access memory are working correctly. The display 10 receives, via the interface unit 30, POST code from the BIOS. The processor 20 converts the POST code into debug code, and controls the display panel 50 to display the debug code.

In the embodiment, the storage unit 40 stores a debug code table that records a detailed description of each debug code. When any hardware is not working correctly, the POST code will remain at the specific address. Then, the debug code corresponding to the POST code will stay unchanged on the display panel 50. When a POST code has stayed unchanged on the display panel 50 for a preset time, the processor 20 reads the debug code table stored in the storage unit 40, determines the detailed description corresponding to the POST code, and controls the display panel 50 to display the determined detailed description accompanying the POST code. As a result, a user will know which piece of the hardware connected to the computer 60 is not working correctly.

In the embodiment, the display panel 50 is a small LED display. The display 10 may be secured to an outer side surface of the side panel 61 of the computer 60. The side panel 61 defines a through hole 611. The display 10 includes a magnetic connection member 90 at its rear. The magnetic connection member 90 includes a hollow barrel 91 and a flange 92 formed at one end of the barrel 91. The barrel 91 is partly fit within the through hole 611, and a cable 80 connecting the motherboard 70 to the interface unit 30 passes through the barrel 91. The flange 92 abuts against the side panel 61 due to magnetic attraction, thereby fixing the display 10 to the side panel 61.

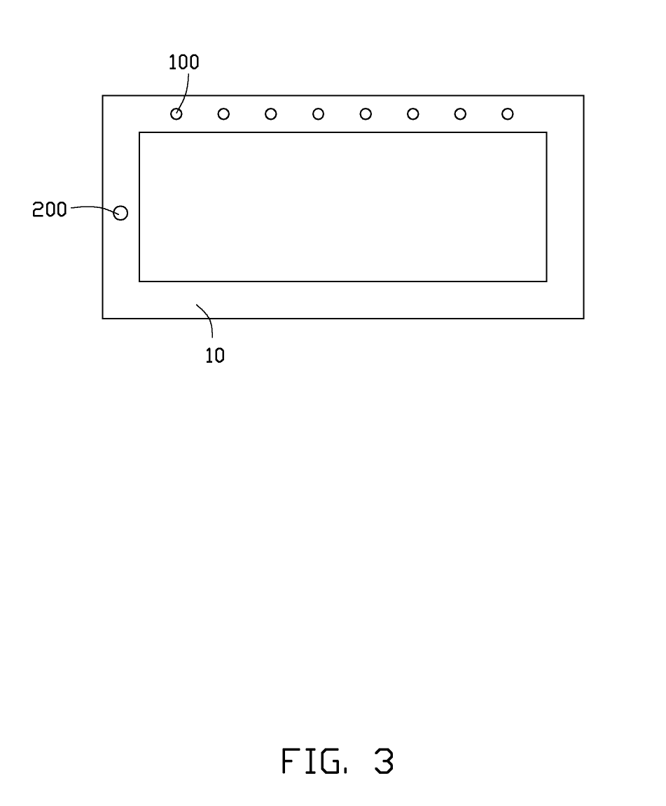

Referring to FIG. 3, in the embodiment, the display 10 may include eight LEDs 100. The eight LEDs 100 are turned on/off by the processor 20 and used to represent a POST code. For example, if a turned-on LED represents “1” and a turned-off LED represent “0” and when a POST code is “10100110”, the eight LEDs 100 will be turned on, off, on, off, off, on, on and off. The display 10 may further include a indicating light 200. When a piece of hardware is not working correctly, the processor 20 turns on the indicating light 200 to alert users.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A display device for being coupled to a computer, the display device comprising:
an interface unit to be connected to a motherboard of the computer;
a display panel; and
a processor electrically coupled to the interface unit, the processor being configured to: receive a power-on self test (POST) code from the motherboard via the interface unit, convert the POST code into a debug code, and control the display panel to display the debug code.

2. The display device according to claim 1, further comprising a storage unit, wherein the storage unit stores a debug code table that stores detailed description corresponding to each debug code, when the display panel has displayed a debug code for a preset time, the processor determines a detailed description corresponding to the debug code and controls the display panel to display the determined detailed description accompanying the debug code.

3. The display device according to claim 1, wherein the display panel is an LED display.

4. The display device according to claim 1, further comprising a magnetic connection member, wherein the display device is coupled to the compute by magnetic attraction between the magnetic connection member and the computer.

5. The display device according to claim 4, wherein the magnetic connection member comprises a hollow barrel and a flange formed at one end of the barrel, the computer defines a through hole, the barrel is partly fit within the through hole, a cable connecting the motherboard and the interface unit passes through the barrel.

6. A computer comprising:
a side panel;
a motherboard; and
a display device coupled to an outer side of the side panel, the display device comprising:
an interface unit connected to the motherboard;
a display panel; and
a processor electrically coupled to the interface unit, the processor being configured to: receive a power-on self test (POST) code from the motherboard via the interface unit, convert the POST code into a debug code, and control the display panel to display the debug code.

7. The computer according to claim 6 further comprising a storage unit, wherein the storage unit stores a debug code table that stores detailed description corresponding to each debug code, when the display panel has displayed a debug code for a preset time, the processor determines a detailed description corresponding to the debug code and controls the display panel to display the determined detailed description accompanying the debug code.

8. The computer according to claim 6, wherein the display panel is an LED display.

9. The computer according to claim 6, further comprising a magnetic connection member, wherein the display device is coupled to the compute by magnetic attraction between the magnetic connection member and the computer.

10. The computer according to claim 9, wherein the magnetic connection member comprises a hollow barrel and a flange formed at one end of the barrel, the side panel defines a through hole, the barrel is partly fit within the through hole, a cable connecting the motherboard and the interface unit passes through the barrel.
